(19) United States
(12) Patent Application Publication
(10) Pub. No.: US 2002/0158462 A1
(43) Pub. Date: Oct. 31, 2002

(54) Kwikstik bookmarker

(76) Inventor: Rupert Antoine, Brampton (CA)

Correspondence Address: EUGENE J. A. GIERZAK, C/O KEYSER MASON BALL, LLP, 201 CITY CENTRE DRIVE, SUITE 701, MISSISSAUGA, ONTARIO, L5B 2T4, CA

(21) Appl. No.: 10/133,447

(22) Filed: Apr. 29, 2002

Related U.S. Application Data
(60) Provisional application No. 60/287,092, filed on Apr. 27, 2001.

(51) Int. Cl. B42D 9/00

(52) U.S. Cl. 281/42

(57) ABSTRACT

A bookmarker adapted to be removably secured to a book comprising first and second tab portions separated by a fold line, bookmarking portion adapted to overlie said tab portion in the region adjacent said fold line, said tab portions including a releasable adhesive for securing said tab portions together, securing said bookmarking portions between said tab portions and releasably securing said bookmarker to said book

### FIELD OF INVENTION

This invention relates generally to bookmarkers and in particular relates to a bookmarker, which may be attached to the spine of a book by means of an adhesive.

### BACKGROUND ART

A plurality of bookmarkers have heretofore been manufactured and used including bookmarkers that are clipped or in some way removably attached to the pages of a book or which are removably attached to the spine of a book.

For example U.S. Pat. No. 5,992,887 relates to a book clasping and page marking device is formed as a generally U-shaped clip for passing around and around the clamping the edges of a set of pages or the cover of a book.

Moreover U.S. Pat. No. 5,911,442 teaches a publication reference aid system apparatus therefore including a plurality of tabs.

Furthermore U.S. Pat. No. 5,305,706 illustrates a page numbering indicating bookmarker capable of being selectively attached to a planar surface in a book which enables the reader to record a desired page number.

Furthermore U.S. Pat. No. 6,056,492 shows a book having a removable bookmark and the method of making a book having a removable bookmark.

Finally U.S. Pat. No. 5,439,254 teaches a method of making a bookmarker which includes selecting a sheet of material, coating a portion of the sheet of material with an adhesive and cutting a plurality of bookmarkers from the sheet of material with each bookmark having an enlarged area having adhesive on one side and an elongated bookmarking portion extending from the enlarged portion. The enlarged portion may have a microencapsulated adhesive coating over one side thereof so that the bookmark can be rapidly attached to a book spine. The bookmark may also be made from a transparent polymer material so as to appear invisible except upon close examination.

These and other bookmarks present relatively complicated structures.

It is an object of this invention to provide an improved bookmark which may be easily manufactured and attached to a book.

It is a further object of this invention to provide a bookmarker which may be easily removably attached to the spine of a book.

It is an aspect of this invention to provide a bookmarker adapted to be removably secured to a book comprising first and second tab portions separated by a fold line, bookmarking portion adapted to overlie said tab portion in the region adjacent said fold line, said tab portions including a releasable adhesive for securing said tab portions together, securing said bookmarking portions between said tab portions and releasably securing said bookmarker to said book.

It is a further aspect of this invention to provide a bookmarker adapted to be removably secured to the spine of a book comprising first and second tabs separated by a fold line, said second tab is smaller than said first tab, bookmarking ribbon adapted to overlie said tab portions in the region adjacent said fold line, said first tab including an adhesive to secure said tabs together, secure said ribbon between said tabs and permit said first tab to be releasably secured to said spine of said book.

It is yet another aspect of this invention to provide a method of applying a bookmarker to a book wherein said bookmarker includes a first and second tab having a fold line therebetween, said method comprising applying a pressure sensitive adhesive to at least said first tab, positioning a ribbon over said fold line and moving said tabs together so as to secure said ribbon therebetween in the region adjacent said fold line, placing said first tab with said adhesive against the spine of said book so as to releasably secure said bookmarker to said book.

These and others objects and features of the invention shall now be described in relation to the following drawings

### BRIEF DESCRIPTION OF DRAWINGS

FIG. 1 illustrates a typical application of the bookmark.

FIG. 2 illustrates a transparent tab version of the bookmark.

FIG. 3 illustrates the insertion of the bookmark in the hardcover book with a crevice in the spine.

FIG. 4 illustrates a hardcover book with a crevice in the spine with the book closed.

FIG. 5 illustrates the bookmarker with ribbons.

FIG. 6 illustrates the bookmark where the tab is larger than the spine of a book.

FIGS. 7 and 8 illustrates the production detail of the bookmark.

FIGS. 9 and 10 illustrates two bookmarks removed from the book having a tremble class indicia on the tab or a maple leaf indicia on the tab.

### DESCRIPTION OF THE INVENTION

In the description which follows, like parts are marked throughout the specification and the drawings with the same respective reference numerals. The drawings are not necessarily to scale and in some instances proportions may have been exaggerated in order to more clearly depict certain features of the invention.

The production detail drawing illustrates the main body of the first tab 2, a fold line 4 and a second tab or fold panel 6 which is smaller in extent than the main body of the first tab 2. One side of the first tab 2 includes an adhesive 8. A ribbon 10 is placed adjacent the adhesive side along the fold line 4 and the fold panel or second tab 6 is disposed so that the sticky side of the adhesive in the fold panel 6 meets the sticky side of the adhesive on main tab 2 so as to secure the two pieces together. It is possible that only the first tab 2 includes the pressure sensitive adhesive. Alternatively the same side of the first and second tab may include the adhesive. In this manner the ribbon 10 is clasped between the tab 2 and the fold panel 6 so that the tab 2 securely retains the ribbon 10 in place. The ribbon 10 therefore includes two bookmarking portions 12,14 where the ends may include tassels portions 16, 18. One side of the tab 2 may include some indicia such as treble clef or maple leaf or other advertising means. Furthermore the tab 2 may be transparent as illustrated in Figure B. Since the first tab 2 is larger than the second tab 6 the adhesive 8 on the surface of the first tab 2 that extends beyond second tab 6 is available for releasable securement to the spine of a book.

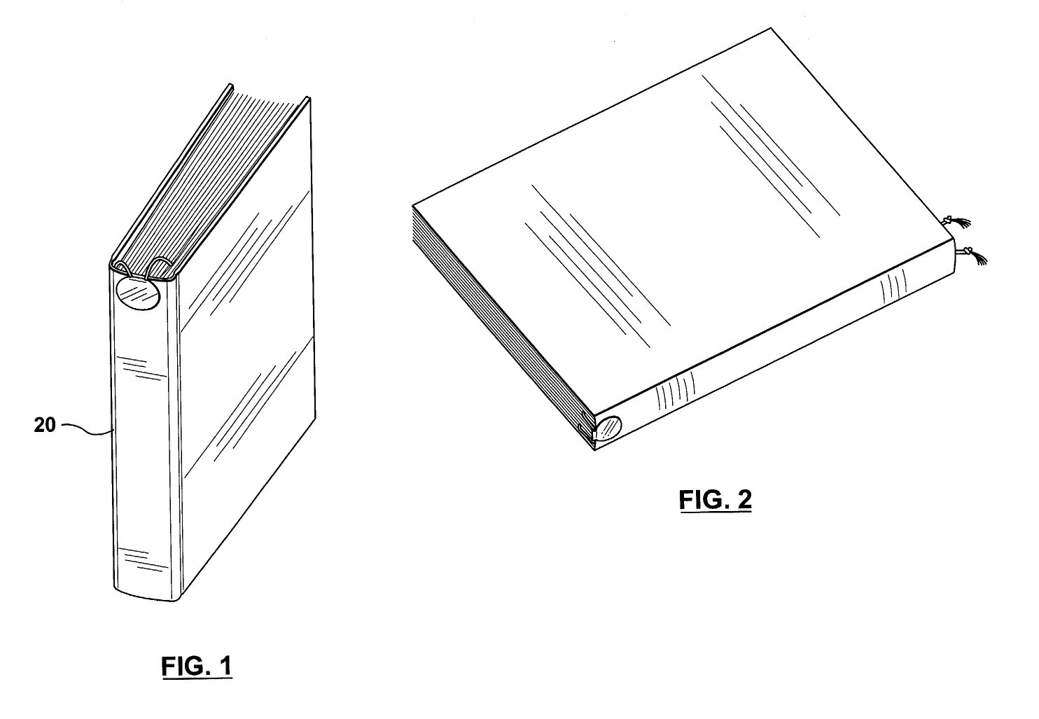

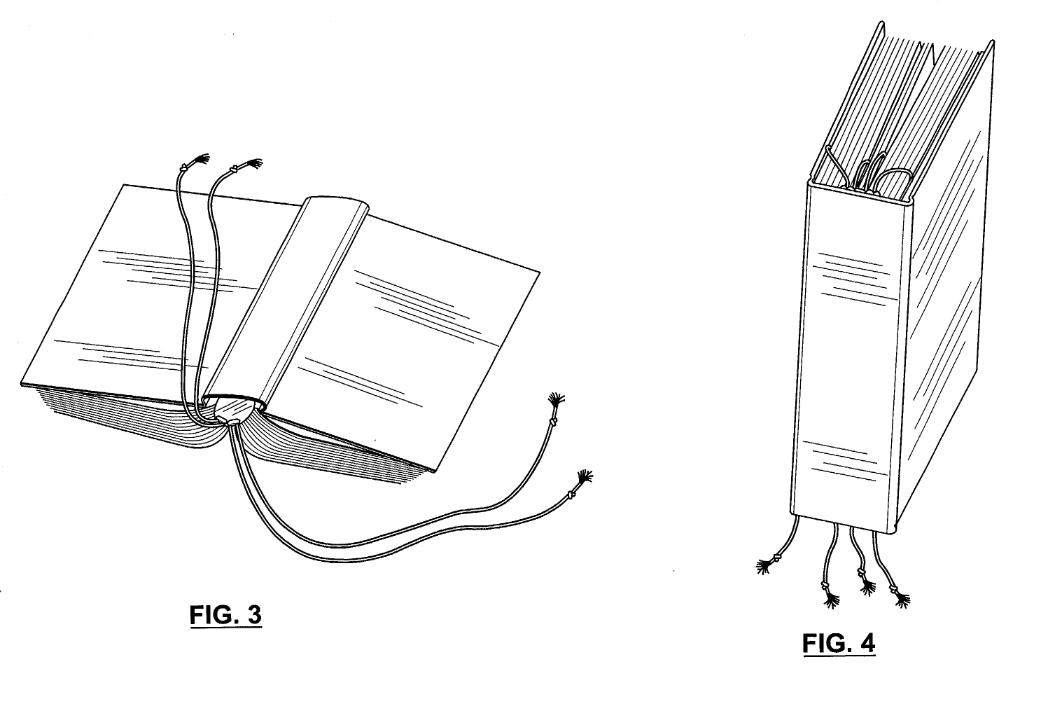

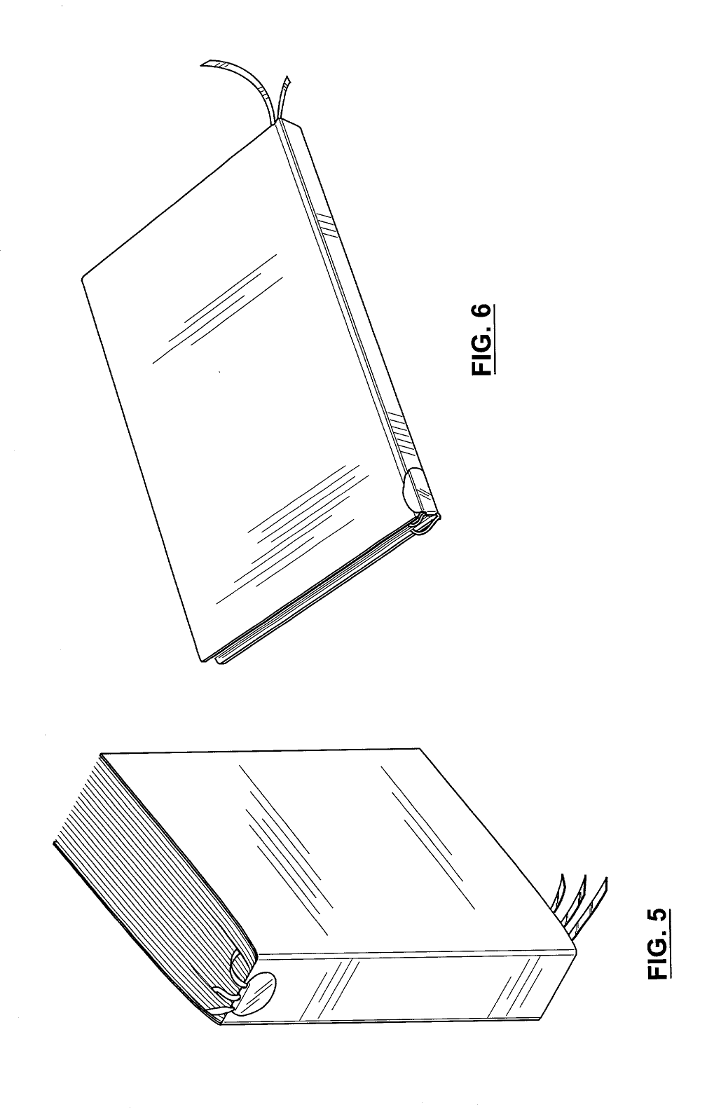

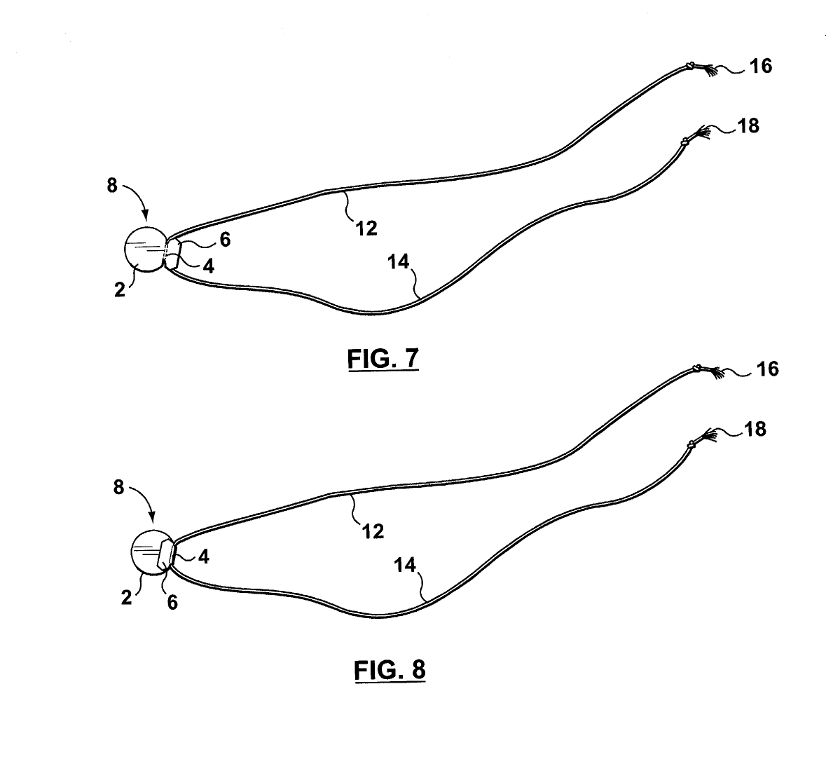

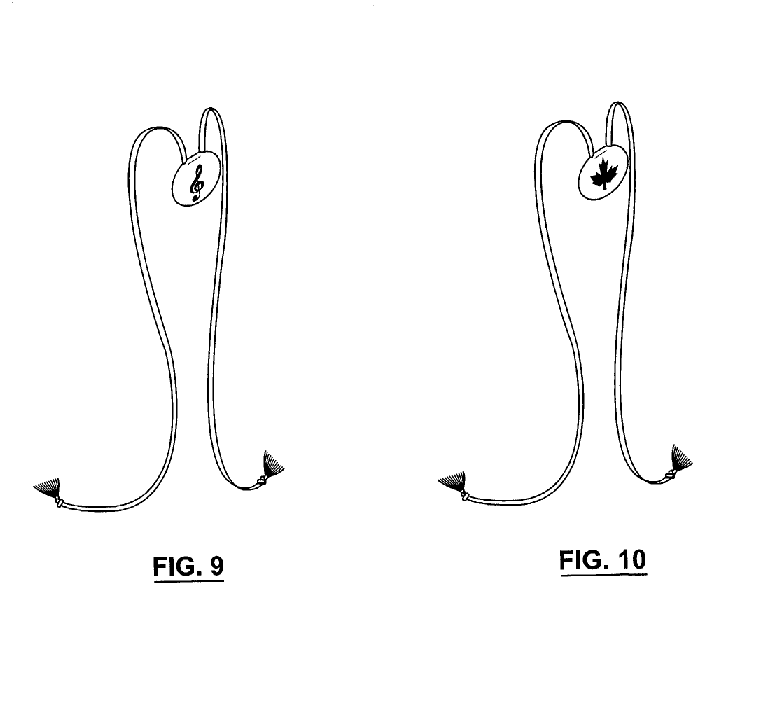

In use the bookmark may be applied to the spine 20 of a book as illustrated in FIG. 1 and the bookmark portions or ribbons 12, 14 mark the appropriate pages as shown. Any number of ribbons or cords may be used as shown in FIG. 3 or other number as required.

Furthermore the bookmark may be inserted into the crevice as shown in FIG. 4 with the sticky side or adhesive side towards the pages. Thereafter the book may be closed and a user firmly presses against the spine with one's finger to firmly secure the tab of the bookmark as shown.

For thinner books as shown in Figure E the tab may be folded around the corners.

Furthermore it would be apparent that one may utilize ribbons or cords with or without tassels.

Furthermore the adhesive may be any variety of adhesive including microencapsulated varieties such as used in post it notes in which case the marker can be reusable.

The bookmarker as shown includes a number of advantages including:

(a) attractive bookmarker remains secured to a reading material to mark a page;

(b) the marker does not fall out of the book;

(c) the bookmarker secures a page or numerous pages;

(d) the bookmarker is simple to use;

(e) the bookmarker saves user time, energy and aggravation while locating a desired page;

(f) the bookmarker as shown eliminates folded page corners or lost bookmarkers;

(g) the bookmarker may be used with a wide array of reading materials including magazines, hardback or paperback books.

The bookmarker can be produced from paper or fabric reinforced vinyl and may be coloured or transparent and measured approximately ⅜ of an inch to one inch in diameter.

Moreover positioned under the underside of the bookmarker is an adhesive material protected by a protective layer such as a section of wax coated paper until needed as shown extending from the top of the bookmarker are one, two or more woven ribbons or chords used to mark locations within a book.

In order to utilize the bookmarker the wax coating from the adhesive material is removed and the tab may be applied to the book spine so that the ribbons extend upward and over through the pages. Furthermore the ribbons or chords may be produced in a variety of eye-catching colours and designs.

Furthermore the tab may be of a variety of colours and may feature a variety of designs including indicia, pictures or symbols. A variety of lengths of bookmark ribbons or chords may be produced to accommodate books of any size. Furthermore the product may be scented to further enhance the users affinity.

The bookmarker shown herein is superior to the bookmarker shown in U.S. Pat. No. 5,439,254 in the following respects:

1. the bookmark shown in U.S. Pat. No. 5,439,254 is relatively stiff and hard to use whereas the invention described herein is relatively flexible with the ribbons shown herein.

2. Furthermore the bookmark illustrated herein more firmly secures the ribbons with the fold panel and tab firmly clasping the ribbons therebetween.

3. Furthermore the adhesive side of the tab illustrated herein includes adhesive only on a portion of the underside of the tab to assist in the easy removal of the bookmarker, if desired. In other words the fold panel 6 of the bookmarker covers of a portion of the adhesive on the back of the tab 2 so as to assist in the easy removal of the bookmarker.

4. More than one page may be marked with the invention described herein.

Although the preferred embodiment as well as the operation and use have been specifically described in relation to the drawings, it should be understood that variations in the preferred embodiment could be achieved by a person skilled in the trade without departing from the spirit of the invention as claimed herein

I claim:

1. A bookmarker adapted to be removably secured to a book comprising:
(a) first and second tab portions separated by a fold line
(b) bookmarking portion adapted to overlie said tab portion in the region adjacent said fold line
(c) said tab portions including a releasable adhesive for:
(i) securing said tab portions together
(ii) securing said bookmarking portions between said tab portions
(iii) releasably securing said bookmarker to said book

2. A bookmarker as claimed in claim 1 wherein said second tab portion is smaller than said first tab portion.

3. A bookmarker as claimed in claim 2 wherein said bookmarking portions comprise a ribbon.

4. A bookmarker as claimed in claim 3 wherein said ribbon includes tassels.

5. A bookmarker as claimed in claim 4 wherein said tab portions comprise plastic.

6. A bookmarker as claimed in claim 5 wherein said tab portions are transparent.

7. A bookmarker as claimed in claim 6 wherein said first tab portion includes indicia.

8. A bookmarker adapted to be removably secured to the spine of a book comprising:
(a) first and second tabs separated by a fold line, said second tab is smaller than said first tab
(b) bookmarking ribbon adapted to overlie said tab portions in the region adjacent said fold line
(c) said first tab including an adhesive to:
(i) secure said tabs together
(ii) secure said ribbon between said tabs
(iii) permit said first tab to be releasably secured to said spine of said book.

9. A bookmarker as claimed in claim 8 wherein said pressure sensitive adhesive of said first tab is adapted to be releasably secured to said spine is disposed on the surface of said first tab extending beyond said second tab.

10. A bookmarker as claimed in claim 9 wherein said tabs are transparent.

11. A bookmarker as claimed in claim 10 wherein said first tab includes indicia on the surface opposite said second tab.

12. A bookmarker as claimed in claim 11 wherein said bookmarker includes a plurality of ribbons.

13. A bookmarker as claimed in claim 12 including a protective layer against said adhesive.

14. A bookmarker as claimed in claim 13 wherein said protective layer comprises a web of paper.

15. A method of applying a bookmarker to a book wherein said bookmarker includes a first and second tab having a fold line therebetween, said method comprising:
(a) applying a pressure sensitive adhesive to at least said first tab
(b) positioning a ribbon over said fold line and moving said tabs together so as to secure said ribbon therebetween in the region adjacent said fold line
(c) placing said first tab with said adhesive against the spine of said book so as to releasably secure said bookmarker to said book.

16. A method as claimed in claim 15 wherein said adhesive is applied to said first and second tabs and said second tab is smaller than said first tab.

17. A method as claimed in claim 16 wherein said first tab is placed in the crevice of said spine of said book and said tab is releasably secured thereto.

18. A method as claimed in claim 17 wherein said tab is larger than said spine of said book and said first tab is folded over and around said spine.
